(19) United States
(12) Patent Application Publication
(10) Pub. No.: US 2025/0335828 A1
(43) Pub. Date: Oct. 30, 2025

(54) METHOD FOR IMPROVING LEARNING UNDER DISTRIBUTION APPROACHES TO AI AGENT ALIGNMENT USING ACTIVE INFERENCE

(71) Applicant: VERSES AI Inc., New Westminster (CA)

(72) Inventors: Sanjeev Namjoshi, Austin, TX (US); Mahault Albarracin, Montreal (CA); Robert Conor Heins, Berlin (DE); Philip Daniel Wilson, Madrid (ES); Kobus Esterhuysen, Custer, WA (US)

(21) Appl. No.: 19/264,878

(22) Filed: Jul. 10, 2025

(51) Int. Cl. G06N 20/00; G06N 7/01

(52) U.S. Cl. CPC G06N 20/00; G06N 7/01

(57) ABSTRACT

A method for improving learning under distribution approaches to AI agent alignment using active inference, wherein an observation method is used to index the likelihood matrix of a Partially Observable Markov Decision Process implemented by an agent, and wherein an action method is used to infer the expected free energy of each possible policy, and wherein an intention method is used to compute the expected value of the expected free energies for each policy, and wherein the policy that affords the least expected value of expected free energies is enacted by the agent.

### FIELD OF THE INVENTION

The invention deals with artificial intelligence software in agent-based systems.

### BACKGROUND

Advances in artificial intelligence (AI) technologies have produced agent-based systems with the capacity to interact with the world and manipulate it toward their own aims. When agents act autonomously (i.e. without direct human intervention, programming, or feedback) there is a risk that they will take actions that are misaligned with human values and goals. There is a great need to develop technologies that allow AI systems to stay aligned with our own goals, especially in domains that involve mission or life-critical systems where failure can be costly both in terms of human lives or monetarily. AI alignment methods use: (i) backward alignment mechanisms that reduce or remove the possibility of unintended or unwanted behaviours in AI systems, that we refer to as agent alignment, and (ii) forward alignment mechanisms that ensure that multiple AI agents remain aligned during task performance once an event that may cause misalignment has occurred (Ji, J., Qiu, T., Chen, B., Zhang, B., Lou, H., Wang, K., Duan, Y., He, Z., Zhou, J., Zhang, Z., Zeng, F., Ng, K. Y., Dai, J., Pan, X., O'Gara, A., Lei, Y., Xu, H., Tse, B., Fu, J., . . . . Gao, W. (2023). AI Alignment: A Comprehensive Survey. In ar Xiv [cs.AI]. arXiv.).

Backward alignment mechanisms for agent alignment include “assurance” and “governance” mechanisms. Assurance mechanisms are applied post-deployment and provide for the evaluation of AI agent-based systems for interpretability and safety. Assurance mechanisms aim at auditing the AI agent-based systems to ensure they are remaining aligned with current human values and intentions. Governance mechanisms rely upon the creation of rules that AI systems must conform with where these rules are devised by humans and encode human values and intentions. These rules may be legal in nature or created for a specific scenario in mind to ensure that the AI system does not produce erroneous outputs.

Forward alignment mechanisms include “learning from feedback” and “learning under distribution shift” mechanisms. Learning from feedback concerns human-AI alignment in terms of human-driven reinforcement. In such a scenario, humans serve as an advisor to ensure the system outputs align with human values and intentions. Learning under distribution shift deals with the scenario where AI systems are trained under one data distribution which then changes in the future, post-deployment, causing the system to become misaligned.

Learning under distribution shift is particularly useful for ensuring alignment in autonomous AI agents that are designed to operate with minimal human intervention. Learning under distribution shift allows the agent to act in a way that aligns with the distribution reflecting the belief of an actor, without explicit intervention of the actor. This, however, poses the problem that without explicit intervention of an actor, an agent has to infer what to do based on some representations of what the intentions of a “typical actor” would be (e.g., when asking “what would a well aligned, typical actor do in my situation?”)—a theory of mind. This requires a form of learning under distribution that considers a mixture of intentions from a variety of actors (e.g., what would my friends, my mother, my brother, my boss, etc., do?).

### SUMMARY OF THE INVENTION

The claimed invention uses an active inference algorithm to improve on learning under distribution forward alignment mechanisms by enabling AI agents to select an action that weighs the intentions of multiple actors. The claimed method allows an AI system to simulate the intentions of another actor (e.g., another AI system or a human) interacting with the system so as to align its behavior with “a typical actor”.

Active inference is an algorithm that applies to predictive statistical models known as generative models and can be used to generate predictions of input data (i.e., “what will happen next”) based on a set of underlying assumptions or Bayesian prior beliefs. As applied to a generative model, active inference allows for the generation of action plans to be performed based on predictions about future inputs. In one embodiment of the claimed method, generative models applying the active inference algorithm use a model structure known as Partially Observable Markov Decision Processes (POMDP). The generative model, which is implemented as a POMDP, and to which the active inference algorithm applies, functions as the agent's model, which is typically implemented in software, and allows a device to infer an action that is to be performed and is referred to as action “policy” (e.g., the action of fetching a box in a warehouse). The generation of action plans by active inference driven agents is achieved by their generative model by comparing the simulated or predicted input to the true received inputs, and by updating prior beliefs and choosing a course of action accordingly, to minimize the difference between the two. Active Inference can be used to simulate inference (i.e., inferring the causes of sensory data in short timescales), parameter specification (i.e., inferring the parameters of the generative model), and structure specification (i.e., specifying the structure of the generative model). The POMDP is defined by 5 sets of parameters of the generative model, denoted A, B, C, D, and E, which represent different aspects of an agent's (or actor's) generative model. The A,B,C,D, and E parameters are written down as matrices or tensors (in higher dimensional cases) as follows. Each parameter is a matrix or tensor in the traditional sense: they are an array of numbers in two (matrix) or multiple (tensor) dimensions. These are stored as an array in a programming language (e.g., Python, Julia, MATLAB).

Parameter A: (the likelihood matrix tensor) represents the likelihood of observing (sensory) data given latent states. It connects data or content to the states that cause that data by modelling the mapping of hidden or latent states (causes) to the agent's input (consequences).

Parameter B: The agent uses the B parameter to predict how its actions will influence the future hidden states.

Parameter C: (the Prior Preference or Goal matrix or tensor) encodes the agent's goals in terms of the preferred data or observational outcomes. The agent uses the C matrix or tensor to evaluate the desirability of different future inputs, which helps guide its actions toward achieving its goals, i.e., satisfying constraints.

Parameter D: (the initial Prior State matrix) relates to the agent's beliefs about the current hidden states of the environment that contextualize state transitions.

Parameter E: (the Habit or action Prior matrix) encodes what the agent will tend to do by default.

In one embodiment of this invention, the code for the method for AI agent alignment through learning under distribution using active inference is implemented as a class in the Python programming language and is composed of an observation method whereby the code allows the agent to use an input observation to index its A matrix, an action method whereby the code allows the agent to compute the expected free energy for all the policies of all the actors and for its own policy, and an intention method whereby the code allows the agent to compute the weighted average, or expected value of the policies of all the actors and of itself that affords the least expected free energy, wherein the expectation uses a weighting distribution that is manually predefined, and where the definition of the of weighing distribution allows a the provider or deployer of the AI agent to decide the influence that actors' belief distribution will have on the agent's decision.

### BRIEF DESCRIPTION OF THE DRAWINGS

FIG. 1 illustrates a flowchart of one embodiment of the invention.

FIG. 2 provides an illustration of the observation method.

FIG. 3 provides an illustration of the action method.

FIG. 4 provides an illustration of the intention method.

FIG. 5 shows one example of a policy matrix.

### DETAILED DESCRIPTION

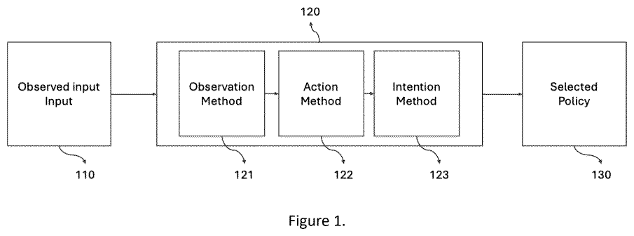

FIG. 1 depicts a flowchart of the method for AI agent alignment through learning under distribution using active inference. An observation is made via sensor, input device, or input from a virtual environment 110, and is fed to an agent model 120 parameterized as an active inference Partially Observable Markov Decision Process (POMDP) with parameters A,B,C,D implemented in programming language. In this embodiment parameter E is not used. The observation method 121 indexes the A matrices of the models of all the actors represented by the agent's model and of its own model, wherein all the models are predefined by the user. The action method 122 is used to compute the expected free energy for the policies of all the models represented by the agent. An agent has its own model defined by the A, B, C, D and possibly E parameters and will represent one or more additional models defining one or more other actors, which may be AI agents or human beings (and which collectively are also referred to herein as actors). The intention method 123 is used to compute the weighted average, or expected value of all the policies computed by the action method 123, wherein the weight distribution is predefined by the user. The agent selects the policy that affords the least weighted expected free energy as its action output 130. This policy is the most probable of all the actors' policies, given a predefined weight attributed to each actor and to the agent.

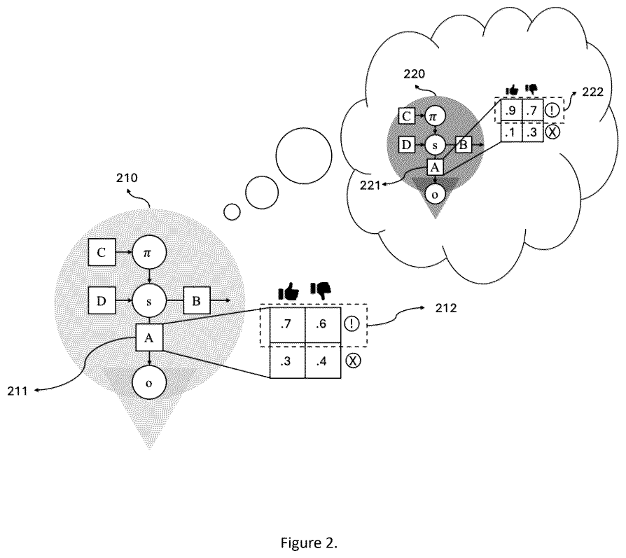

FIG. 2 depicts the observation method in reference numeral 121 of FIG. 1. Reference numeral 210 of FIG. 2 depicts the model of an agent implementing a POMDP with active inference parameters A,B,C,D such as known in the arts (Smith, R., Friston, K. J., & Whyte, C. J. (2022). A step-by-step tutorial on active inference and its application to empirical data. Journal of Mathematical Psychology, 107). The representation of the model of an actor by the agent, with which the agent seeks to align corresponds to reference numeral 220. The observation method is used to index the row of the likelihood matrix of the agent model A 211 corresponding to the perceived input (e.g., a green sign) 212. The likelihood matrix maps all the possible inputs, or observations of the agent onto all the possible states associated with those inputs and is represented by the agent model (e.g., the probability mapping that a “!” sign is associated with a “go” action or a “no go” action, and the probability that a “X” sign is associated with a “go” action or a “no go” action). The code implementing the observation method indexes the representation of the A matrix 221 of one or more actors represented by the agent 222, and is used to infer a posterior distribution used in the computation of expected free energy, such as known in the arts (Smith, R., Friston, K. J., & Whyte, C. J. (2022). A step-by-step tutorial on active inference and its application to empirical data. Journal of Mathematical Psychology, 107).

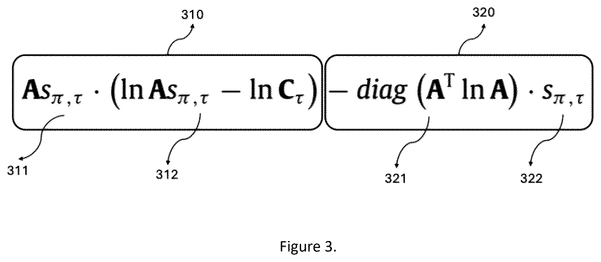

FIG. 3 depicts the formula to compute the expected free energy for each possible policy under the action method depicted by reference numeral 122 in FIG. 1, wherein the difference of the log probability of the product of the A matrix and the approximate posterior (s_pi,t) (ln(As_pi,t)) define the minimization of free energy such as known in the arts based on the indexed likelihood matrix A (Smith, R., Friston, K. J., & Whyte, C. J. (2022). A step-by-step tutorial on active inference and its application to empirical data. Journal of Mathematical Psychology, 107), and the log probability of the C parameter at time t (ln(C_t)) (312) is used in a dot product (.) with As_pi,t (311) to obtain the value for the first component of expected free energy (As_pi,t.(ln(As_pi,t−ln(C_t)) (310), where the expected free energy value is the difference between the first component and the second component (320) corresponding to the negative of the dot product (.) of the diagonal elements of the transpose (T) of the A matrix A^{T} (321) multiplied by the log probability of the A matrix (ln(A)) (−diag(ATInA)) and the posterior distribution s_pi,t (322), such as known in the arts (Smith, R., Friston, K. J., & Whyte, C. J. (2022). A step-by-step tutorial on active inference and its application to empirical data. Journal of Mathematical Psychology, 107), and wherein the expected free energy G is calculated for each time point, and wherein an active inference algorithm is used to compute the expected free energy of the action policies of all the possible actions of the agents, including the action of inquiring on additional information by querying the user and the action of accomplishing the task queried by the user, wherein the action policy with the least expected free energy is the action policy engaged by the agent to control the device, and wherein the inference of the action policy and device control uses an active inference algorithm that includes one or more of belief propagation, variational message passing, Laplace propagation, and Expectation Propagation algorithms, wherein the expected free energy of policies over multiple time points is the sum of expected free energy for each time point.

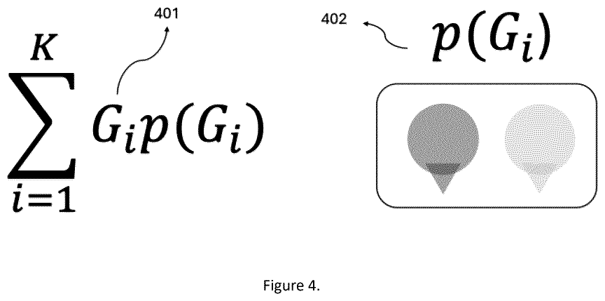

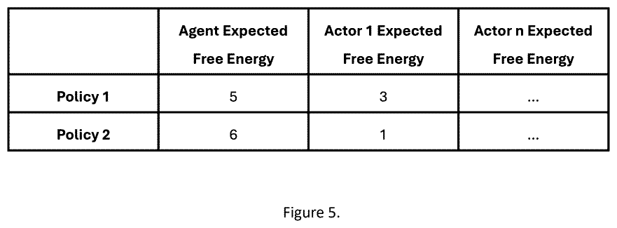

FIG. 4 depicts the formula to compute the policy to be selected under the intention method depicted by reference numeral 123 in FIG. 1. The policy with the least expected free energy denoted as “G” of each agent (G_i) (401) is weighted by a user defined distribution p(G_i) (402) designed to attribute a desired weight to the policy selection process. For instance, if the agent and the actor represented by the agent have access to two possible action policies pi_1 and pi_2, and if the expected free energy score “G” of pi_1 for the agent is say, 5, and for the actor is say, 3 (meaning that pi_1 such as computed based on the represented model of the actor is better than the pi_1 based on the model of the agent), and if the weight distribution is 0.7 for the agent's policies and 0.3 for the actor's policies, then the expected value of pi_1 will be 4.4 (i.e., 5*7+3*3). In turn, if the G for pi_2 of the agent is 6 and pi_2 of the actor is 1, then the expected value for pi_2 is 4.5. The expected free energy for all the policies can be stored in a policy matrix with rows indicating policy number and with columns indicating the expected free energy value for that policy for an agent. The selected policy to be enacted by the agent in reference numeral 130 of FIG. 1 will be pi_1 as it affords the least weighted G. One example of a policy matrix is shown in FIG. 5.

FIG. 5 illustrates a policy matrix storing the expected free energy for each policy with columns indicating the expected free energy of each model for a given policy and with the rows indicating the number of the policies.

While the present invention is described with respect to specific implementations, it will be appreciated that it could be implemented with all 5 POMDP parameters and adjusted for specifical applications without departing from the scope of the invention as defined in the claims.

The claimed invention is:

1. A method performed by one or more computers to improve on learning under distribution approaches to AI agent alignment using active inference, comprising:
parameterizing an agent model as a Partially Observable Markov Decision Process (POMDP) to which an active inference algorithm can be applied, and wherein the parameters of the POMDP are A,B,C,D parameters, which are each represented as matrices or tensors, and wherein the agent model represents its own POMDP model and one or more other POMDP models, the A parameter being defined as a likelihood matrix that defines mappings between observation inputs and their associated world states;
defining a weight distribution that attributes a weight to each POMDP model represented by the agent model, wherein the number of elements in the weight distribution corresponds to the number of policies available to the agent model and to the one or more other POMDP models, and wherein all the represented POMDP models have the same number of available policies as the agent model;
receiving an observation input generated by a real or virtual environment, wherein the observation input is captured via a real or virtual sensor or input device;
indexing the row of the likelihood matrix A corresponding to the observation input for all the POMDP models represented by the agent;
computing the expected free energy of all the policies across all the models represented by the agent, including the agent's own model;
storing the expected free energy for each policy;
calculating the expected value of each row of the policy matrix using the predefined weight distribution; and
selecting as the policy to be enacted by the agent, using programming language, the policy that corresponds to the row of the policy matrix with the least expected value.

2. The method of claim 1, wherein the indexed likelihood matrix A is used to compute the approximate posterior distribution over states for each POMDP model through the minimization of free energy.

3. The method of claim 1, wherein the expected free energy for each policy is stored in a policy matrix with columns indicating the expected free energy of each model for a given policy and with the rows indicating the number of the policies.

4. The method of claim 1, wherein the expected free energy is obtained by computing the difference of the log probability of the product of the A matrix and (s_pi,t) (ln(As_pi,t)) and the log probability of the C parameter at time t (ln(C_t)) (312) used in a dot product (.) with As_pi,t (311) to obtain the value for the first component of expected free energy (As_pi,t.(ln(As_pi,t−ln(C_t)) (310), and by computing the difference between the first component and the second component (320) corresponding to the negative of the dot product (.) of the diagonal elements of the transpose (T) of the A matrix AT (321) multiplied by the log probability of the A matrix (ln(A)) (−diag(ATInA)) and the posterior distribution s_pi,t (322).
